(19) United States
(12) Patent Application Publication
(10) Pub. No.: US 2024/0292224 A1
(43) Pub. Date: Aug. 29, 2024

(54) TARGETED SIDELINK DENIAL OF SERVICE (DOS) DETECTION VIA INTER-USER EQUIPMENT (UE) COORDINATION MESSAGE

(71) Applicant: QUALCOMM Incorporated, San Diego, CA (US)

(72) Inventors: Mohammad NEKOUI, San Diego, CA (US); Soumya DAS, San Diego, CA (US)

(21) Appl. No.: 18/176,271

(22) Filed: Feb. 28, 2023

(51) Int. Cl. H04W 12/122; H04L 9/40; H04W 12/00; H04W 12/108

(52) U.S. Cl. CPC H04W 12/122; H04L 63/1458; H04W 12/009; H04W 12/108

(57) ABSTRACT

Disclosed are systems, apparatuses, processes, and computer-readable media for wireless communications. For example, a computing device can transmit a number of fake inter-UE coordination (IUC) messages to reserve one or more resources for initial transmissions by the computing device. The computing device can receive one or more packets on at least one of the one or more resources. The computing device can further determine whether at least one of the one or more packets were transmitted by an attacker based on a jamming threshold.

### FIELD

The present disclosure generally relates to vehicle communications. For example, aspects of the present disclosure relate to targeted sidelink denial of service (DOS) detection via an inter-user equipment (UE) coordination message.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in vehicle-to-everything (V2X), vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for targeted sidelink DoS detection via an inter-UE coordination message. According to at least one illustrative example, a method is provided for wireless communications by a device. The method includes: transmitting, by the device, a number of fake inter-UE coordination (IUC) messages to reserve one or more resources for initial transmissions by the device; receiving, by the device, one or more packets on at least one of the one or more resources; and determining, by the device, whether at least one of the one or more packets were transmitted by an attacker based on a jamming threshold.

In another illustrative example, an apparatus for wireless communications is provided. The apparatus comprises at least one memory and at least one processor coupled to the at least one memory and configured to: output for transmission a number of fake inter-UE coordination (IUC) messages to reserve one or more resources for initial transmissions by the apparatus; receive one or more packets on at least one of the one or more resources; and determine whether at least one of the one or more packets were transmitted by an attacker based on a jamming threshold.

In another illustrative example, a non-transitory computer-readable medium is provided having stored thereon instructions that, when executed by at least one processor, cause the at least one processor to: output for transmission a number of fake inter-UE coordination (IUC) messages to reserve one or more resources for initial transmissions by the apparatus; receive one or more packets on at least one of the one or more resources; and determine whether at least one of the one or more packets were transmitted by an attacker based on a jamming threshold.

In another illustrative example, an apparatus for wireless communications is provided. The apparatus comprises: means for transmitting a number of fake inter-UE coordination (IUC) messages to reserve one or more resources for initial transmissions by the apparatus; means for receiving one or more packets on at least one of the one or more resources; and means for determining whether at least one of the one or more packets were transmitted by an attacker based on a jamming threshold.

In another illustrative example, a method is provided for wireless communications by a device. The method includes: reserving, by the device, one or more resources for initial transmissions and retransmissions by the device using a semi-persistent scheduling (SPS) scheme; receiving, by the device in mute and listen slots, one or more packets; determining, by the device, whether an attacker transmitted at least one of the one or more packets; and transmitting, by the device and based on at least one of the one or more packets being determined to be transmitted by the attacker, aperiodic transmissions.

In another illustrative example, an apparatus for wireless communications is provided. The apparatus comprises at least one memory and at least one processor coupled to the at least one memory and configured to: reserve one or more resources for initial transmissions and retransmissions by the apparatus using a semi-persistent scheduling (SPS) scheme; receive, in mute and listen slots, one or more packets; determine whether an attacker transmitted at least one of the one or more packets; and based on at least one of the one or more packets being determined to be transmitted by the attacker, output aperiodic transmissions.

In another illustrative example, a non-transitory computer-readable medium is provided having stored thereon instructions that, when executed by at least one processor, cause the at least one processor to: reserve one or more resources for initial transmissions and retransmissions by the apparatus using a semi-persistent scheduling (SPS) scheme; receive, in mute and listen slots, one or more packets; determine whether an attacker transmitted at least one of the one or more packets; and based on at least one of the one or more packets being determined to be transmitted by the attacker, output aperiodic transmissions.

In another illustrative example, an apparatus for wireless communications is provided. The apparatus comprises: means for reserving one or more resources for initial transmissions and retransmissions by the apparatus using a semi-persistent scheduling (SPS) scheme; means for receiving, in mute and listen slots, one or more packets; means for determining whether an attacker transmitted at least one of the one or more packets; and means for transmitting, based on at least one of the one or more packets being determined to be transmitted by the attacker, aperiodic transmissions.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, is part of, or includes a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIG. 2 is a diagram illustrating an example of a disaggregated base station architecture, which may be employed by the disclosed system for geolocation of key critical driver behavior and safety hazards, in accordance with some aspects of the present disclosure.

FIG. 3 is a diagram illustrating an example of various user equipment (UEs) communicating over direct communication interfaces (e.g., a cellular based PC5 sidelink interface, 802.11p defined dedicated short-range communications (DSRC) interface, or other direct interface) and wide area network (Uu) interfaces, in accordance with some aspects of the present disclosure.

FIG. 4 is a block diagram illustrating an example of a computing system of a vehicle, in accordance with some aspects of the present disclosure.

FIG. 5 is a diagram illustrating an example of a system for sensor sharing in wireless communications (e.g., V2X communications), in accordance with some aspects of the present disclosure.

FIG. 6 is a diagram illustrating an example of a vehicle-based message (shown as a sensor-sharing message), in accordance with some aspects of the present disclosure.

FIG. 7 is a diagram illustrating an example of a resource block with aperiodic transmissions, in accordance with some aspects of the present disclosure.

FIG. 8 is a diagram illustrating an example of a resource block with inter-UE coordination, in accordance with some aspects of the present disclosure.

FIG. 9 is a diagram illustrating an example of a resource block with inter-UE information, in accordance with some aspects of the present disclosure.

FIG. 10 is a diagram illustrating example ranges for a number of inter-UE coordination (IUC) messages, in accordance with some aspects of the present disclosure.

FIG. 11 is a graph illustrating an example showing the relationship between a channel busy ratio (CBR) and a jamming threshold, in accordance with some aspects of the present disclosure.

FIG. 12 is a flow chart illustrating an example of a method for targeted sidelink DoS detection via an inter-UE coordination message, in accordance with some aspects of the present disclosure.

FIG. 13A is a flow chart illustrating an example of a process for wireless communications, according to some aspects of the present disclosure.

FIG. 13B is a flow chart illustrating another example of a process for wireless communications, according to some aspects of the present disclosure.

FIG. 14 illustrates an example computing system, according to aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, vehicle-to-grid (V2G) communications (e.g., data going to the electric grid, such as for the purpose of actively managing energy in electric vehicles or other electric devices or systems), which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), and/or other types of vehicle-based messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

As previously mentioned, the V2X technology includes V2V communications, which can also be referred to as peer-to-peer communications. V2V communications allows for vehicles to directly wireless communicate with each other while on the road. With V2V communications, vehicles can gain situational awareness by receiving information regarding upcoming road dangers (e.g., unforeseen oncoming vehicles, accidents, and road conditions) from the other vehicles.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

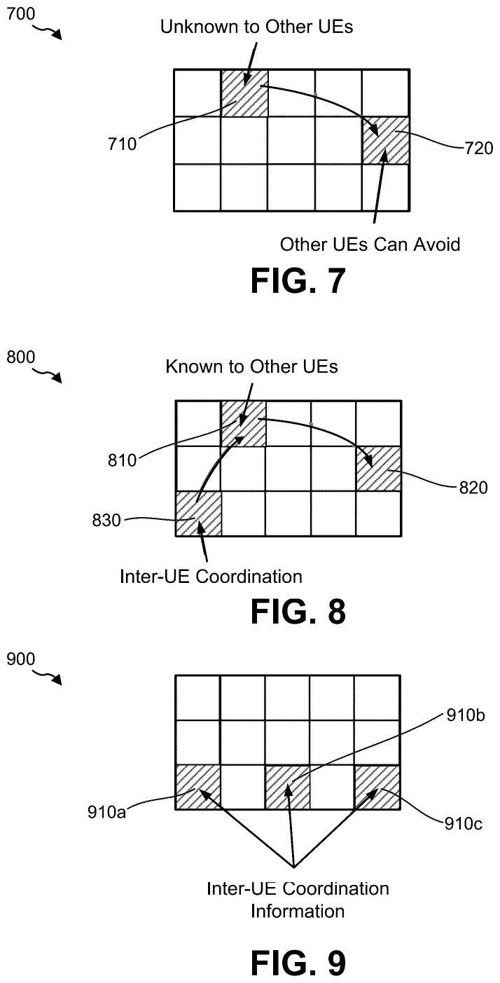

Currently, for NR-V2X aperiodic transmissions, an attacker (e.g., an adversary) cannot target an initial transmission (Tx) of a UE because initial transmission resources (such as resource elements of resource block 700 of FIG. 7) are not reserved by the transmitting UE (as opposed to a semi-persistent scheduling scheme). However, 3GPP Release 17 provides inter-UE coordination enhancements that allow for a UE to indicate its own initial transmission as a “non-preferred” resource (such as resource element 810 of FIG. 8) through an inter-UE coordination (IUC) message (such as IUC message in resource element 830 of FIG. 8). These enhancements can be exploited by an attacker to corrupt the initial transmission of a UE. As such, an improved technique that provides for detection of an attacker, while allowing for UEs to employ IUC messages, can be useful.

Systems and techniques are provided for targeted sidelink DoS detection via an inter-UE coordination message. The systems and techniques can allow for UEs to exploit IUC messages to detect an attacker and take mitigation. The systems and techniques can also allow for detection of a sidelink attack during a semi-persistent scheduling regime.

In one or more aspects, a UE can send N number of fake IUC messages as “bait” to prospective attackers to indicate a supposed initial transmission, where the number N is chosen based on a channel busy ratio (CBR). An attacker can receive the fake IUC messages and, subsequently, try to jam the upcoming supposed initial transmission. The UE can refrain from transmitting in that resource, and instead listen to detect any potential attacker packets. Based on the number of received packets during the listening slot being greater than a value of a jamming threshold (e.g., which can be based on the CBR), an attacker can be detected.

In some aspects, once an attacker has been detected, a vehicle (e.g., a host vehicle) can include attacker information in a SDSM (e.g., with related information, such as the UE's own (victim's) L2 address, the attacker's L2 address and position, etc.). Additionally, the UE can refrain from sending the entire (e.g., omit parts of) the IUC message. If a vehicle has not received an SDSM indicating that other vehicles are being targeted by the attacker, the vehicle can still send the IUC message, but not include its own initial transmission in it. If a vehicle has received SDSMs from other vehicles indicating an attacker targeting others, the vehicle can stop sending IUC messages altogether.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

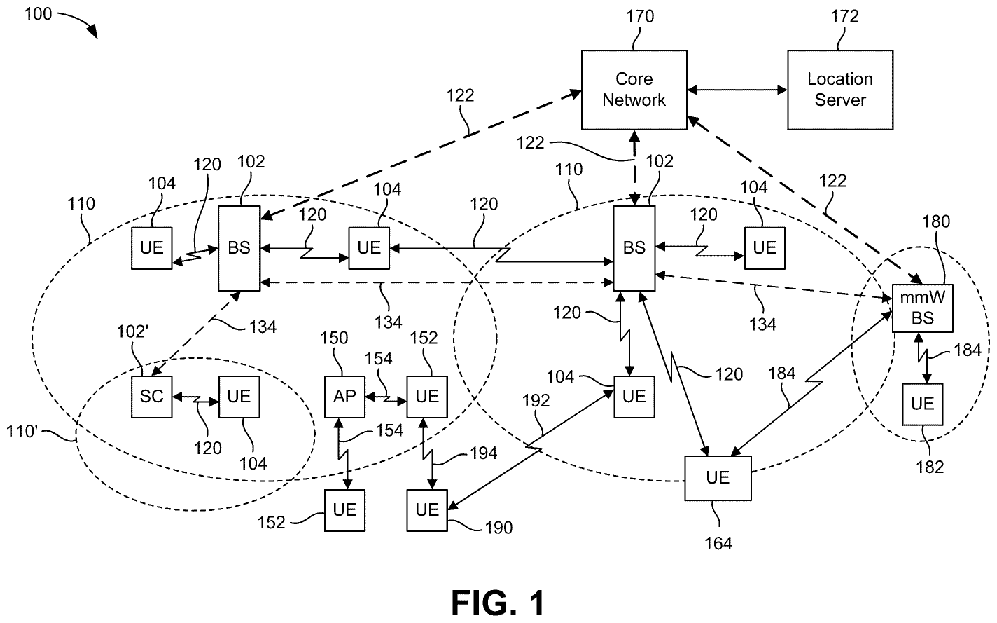

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mm W or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

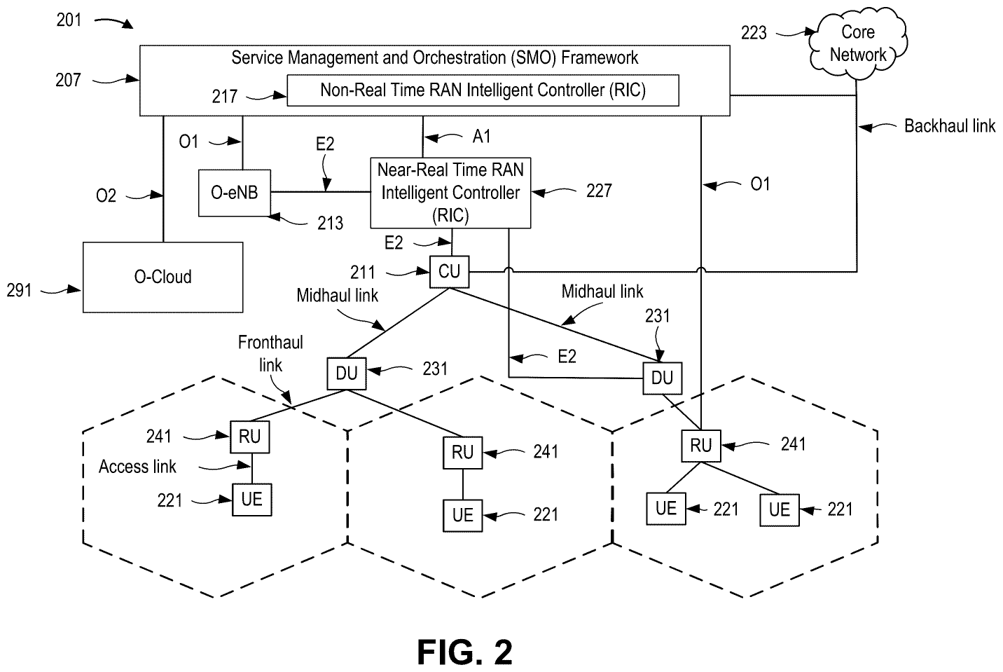

FIG. 2 is a diagram illustrating an example of a disaggregated base station architecture, which may be employed by the disclosed system for targeted sidelink DoS detection via an inter-UE coordination message. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 131, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via 01) or via creation of RAN management policies (such as A1 policies).

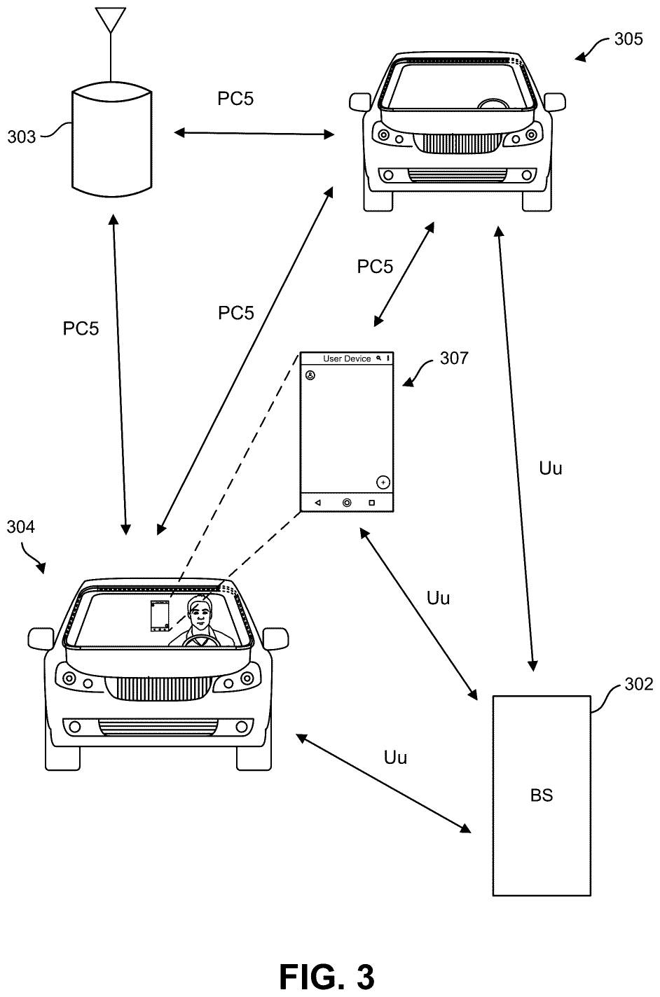

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

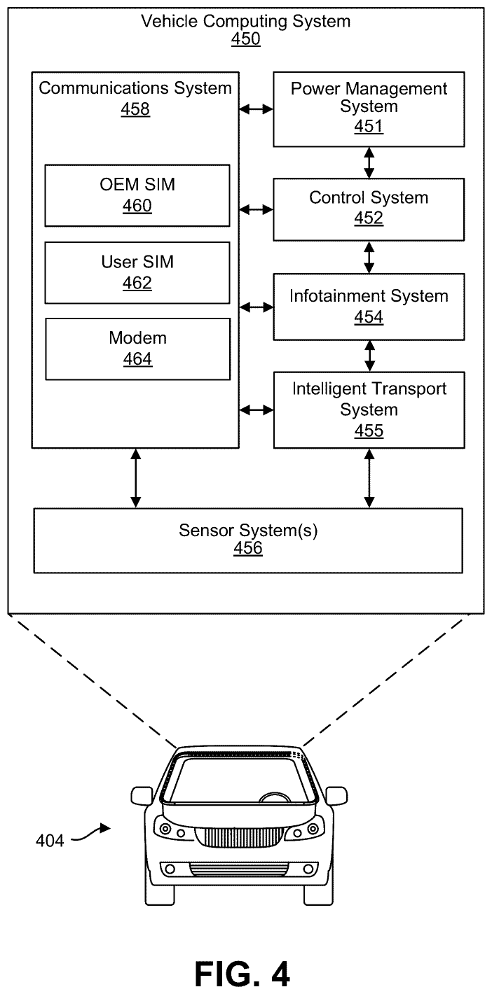

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. The SIM 460 can include a hardware SIM, a software-based SIM (or eSIM) (e.g., a programmable SIM card), any combination thereof, and/or other types of SIMs. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

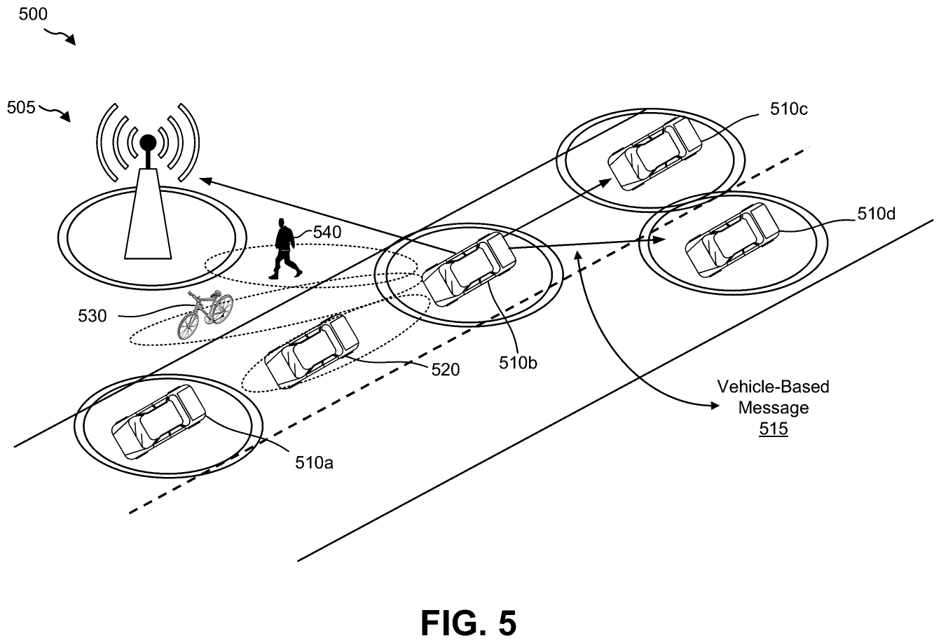

FIG. 5 is a diagram illustrating an example of a system 500 for sensor sharing in wireless communications (e.g., V2X communications). In FIG. 5, the system 500 is shown to include a plurality of equipped (e.g., V2X capable) network devices. The plurality of equipped network devices includes vehicles (e.g., automobiles) 510a, 510b, 510c, 510d, and an RSU 505. Also shown are a plurality of non-equipped network devices, which include a non-equipped vehicle 520, a VRU (e.g., a bicyclist) 530, and a pedestrian 540. The system 500 may comprise more or less equipped network devices and/or more or less non-equipped network devices, than as shown in FIG. 5. In addition, the system 500 may comprise more or less different types of equipped network devices (e.g., which may include equipped UEs) and/or more or less different types of non-equipped network devices (e.g., which may include non-equipped UEs) than as shown in FIG. 5. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In one or more examples, vehicles 510a, 510b, 510c, 510d and RSU 505 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 500. For example, vehicle 510b may be a luxury vehicle and, as such, have more expensive, higher capability sensors than other vehicles that are economy vehicles. In one illustrative example, vehicle 510b may have one or more higher capability LIDAR sensors (e.g., high capability optical lasers and optical sensors) than the other equipped network devices in the system 500. In one illustrative example, a LIDAR of vehicle 510b may be able to detect a VRU (e.g., cyclist) 530 and/or a pedestrian 540 with a large degree of confidence (e.g., a seventy percent degree of confidence). In another example, vehicle 510b may have higher capability radar (e.g., high capability RF antennas) than the other equipped network devices in the system 500. For instance, the radar of vehicle 510b may be able to detect the VRU (e.g., cyclist) 530 and/or pedestrian 540 with a degree of confidence (e.g., an eight-five percent degree of confidence). In another example, vehicle 510b may have higher capability camera (e.g., with higher resolution capabilities, higher frame rate capabilities, better lens, etc.) than the other equipped network devices in the system 500.

During operation of the system 500, the equipped network devices (e.g., RSU 505 and/or at least one of the vehicles 510a, 510b, 510c, 510d) may transmit and/or receive sensing signals (e.g., RF and/or optical signals) to sense and detect vehicles (e.g., vehicles 510a, 510b, 510c, 510d, and 520) and/or objects (e.g., VRU 530 and pedestrian 540) located within and surrounding the road. The equipped network devices (e.g., RSU 505 and/or at least one of the vehicles 510a, 510b, 510c, 510d) may then use the sensing signals to determine characteristics (e.g., motion, dimensions, type, heading, and speed) of the detected vehicles and/or objects. The equipped network devices (e.g., RSU 505 and/or at least one of the vehicles 510a, 510b, 510c, 510d) may generate at least one vehicle-based message 515 (e.g., a V2X message, such as a Sensor Data Sharing Message (SDSM), a Basic Safety Message (BSM), a Cooperative Awareness Message (CAM), Collective Perception Messages (CPMs), and/or other type of message) including information related to or associated with the determined characteristics of the detected vehicles and/or objects.

The vehicle-based message 515 may include information related to or associated with the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 515 may also include information regarding the equipped network device's preference to receive vehicle-based messages from other certain equipped network devices. In some cases, the vehicle-based message 515 may include the current capabilities of the equipped network device (e.g., vehicles 510a, 510b, 510c, 510d), such as the equipped network device's sensing capabilities (which can affect the equipped network device's accuracy in sensing vehicles and/or objects), processing capabilities, the equipped network device's thermal status (which can affect the vehicle's ability to process data), and the equipped network device's state of health.

In some aspects, the vehicle-based message 515 may include a dynamic neighbor list (also referred to as a Local Dynamic Map (LDM) or a dynamic surrounding map) for each of the equipped network devices (e.g., vehicles 510a, 510b, 510c, 510d and RSU 505). For example, each dynamic neighbor list can include a listing of all of the vehicles and/or objects that are located within a specific predetermined distance (or radius of distance) away from a corresponding equipped network device. In some cases, each dynamic neighbor list includes a mapping, which may include roads and terrain topology, of all of the vehicles and/or objects that are located within a specific predetermined distance (or radius of distance) away from a corresponding equipped network device.

In some implementations, the vehicle-based message 515 may include a specific use case or safety warning, such as a do-not-pass warning (DNPW) or a forward collision warning (FCW), related to the current conditions of the equipped network device (e.g., vehicles 510a, 510b, 510c, 510d). In some examples, the vehicle-based message 515 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

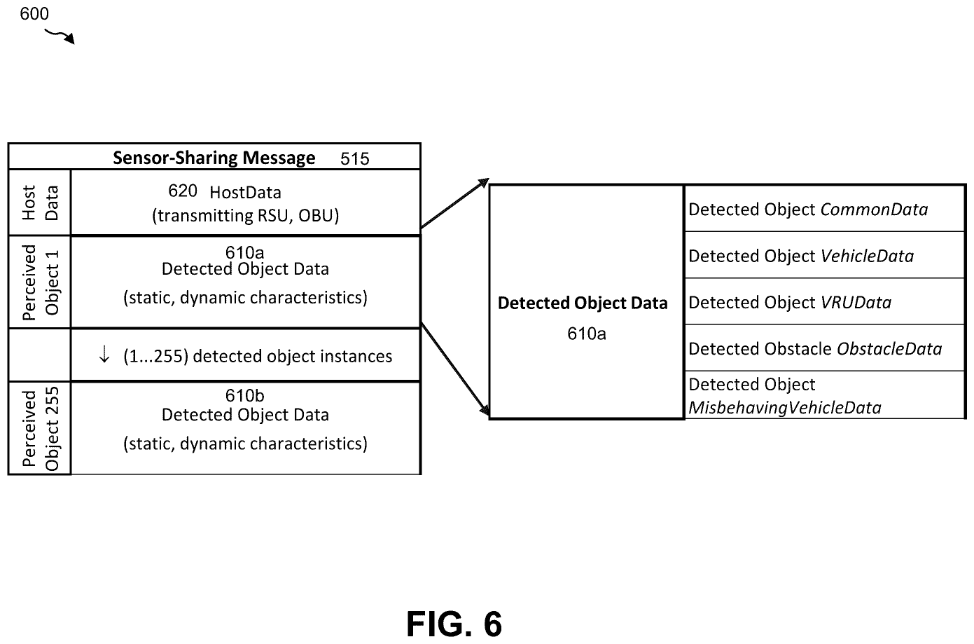

FIG. 6 is a diagram 600 illustrating an example of a vehicle-based message (e.g., vehicle-based message 515 of FIG. 5). The vehicle-based message 515 is shown as a sensor-sharing message (e.g., an SDSM), but can include a BSM, a CAM, a CPM, or other vehicle-based message as noted herein. In FIG. 6, the vehicle-based message 515 is shown to include HostData 620 and Detected Object Data 610a, 610b. The HostData 620 of the vehicle-based message 515 may include information related to the transmitting device (e.g., the transmitting equipped network entity, such as RSU 505 or an onboard unit (OBU), such as on vehicles 510a, 510b, 510c, 510d) of the vehicle-based message 515. The Detected Object Data 610a, 610b of the vehicle-based message 515 may include information related to the detected vehicle or object (e.g., static or dynamic characteristics related to the detected vehicle or object, and/or other information related to the detected vehicle or object). The Detected Object Data 610a, 610b may specifically include Detected Object CommonData, Detected Object VehicleData, Detected Object VRUData, Detected Obstacle ObstacleData, and Detected Object Misbehaving VehicleData.

These vehicle-based messages 515 are beneficial because they can provide an awareness and understanding to the equipped network devices (e.g., vehicles 510a, 510b, 510c, 510d of FIG. 5) of upcoming potential road dangers (e.g., unforeseen oncoming vehicles, accidents, and road conditions).

As previously mentioned, for NR-V2X aperiodic transmissions, an attacker (e.g., an adversary) cannot target an initial transmission (Tx) of a UE because initial transmission resources (such as resource element of resource block 700 of FIG. 7) are not reserved by the transmitting UE (as opposed to a semi-persistent scheduling scheme)

FIG. 7 shows an example of NR-V2X aperiodic transmissions In particular, FIG. 7 is a diagram illustrating an example of a resource block (RB) 700 with aperiodic transmissions. In FIG. 7, the RB 700 is arranged with the time domain on the horizontal (or x-) axis and the frequency domain on the vertical (or y-) axis. For example, the RB 700 may be 180 kilohertz (kHz) wide in frequency and one slot long in time (with a slot being 1 ms in time). The RB 700 is shown to include three subcarriers (along the y-axis) and five symbols (along the x-axis). An intersection of a symbol and subcarrier can be referred to as a resource element (RE) or tone. For instance, an RE is 1 subcarrier x 1 symbol, and is the smallest discrete part of the subframe. An RE includes a single complex value representing data from a physical channel or signal.

Combination (comb) structures (also referred to as tone patterns) can be defined as specific arrangements of REs in a given resource block for transmission of a reference signal. Comb structures are currently pre-defined in the 3GPP communication standards (e.g., 5G/NR, 4G/LTE, etc.) and may be known to both the UE and corresponding network entity (e.g., base station or portion thereof).

In FIG. 7, for NR-V2X aperiodic transmissions, initial transmission resources (e.g., RE 710) cannot be reserved by a UE (e.g., a device, such as user device 104 of FIG. 1 or UE 221 of FIG. 2). Since the initial transmission resources (e.g., RE 710) cannot be reserved by the UE, other UEs (as well as potential attackers) will be unaware of the UE using these resources (e.g., RE 710) for its initial transmissions and, as such, an attacker will not be able to specifically target the initial transmissions transmitted within those resources (e.g., RE 710).

However, for NR-V2X aperiodic transmissions, retransmission resources (e.g., RE 720) can be reserved (e.g., within sidelink control information (SCI)) by a UE. Since the retransmission resources (e.g., RE 720) can be reserved by the UE, other UEs can be aware (e.g., via the SCI) of the UE using these resources (e.g., RE 720) for its retransmissions and, as such, the other UEs can avoid transmitting within those resources (e.g., RE 720). However, since the retransmission resources (e.g., RE 720) can be reserved by the UE, an attacker can also be aware (e.g., via the SCI) of those resources (e.g., RE 720) being used, and be able to target the retransmissions transmitted within those resources (e.g., RE 720) by transmitting signals at the same time and frequency as those resources to jam those retransmission resources (e.g., RE 720) and cause the retransmissions packets to be dropped.

Conversely to NR-V2X aperiodic transmissions, for a semi-persistent scheduling (SPS) scheme, initial transmission resources can be reserved by a UE.

As previously mentioned, 3GPP Release 17 provides inter-UE coordination (IUC) enhancements that allow for a UE to indicate its own initial transmission as a “non-preferred” resource (e.g., RE 810 of FIG. 8) through an IUC message (e.g., IUC message in RE 830 of FIG. 8). These enhancements can be exploited by an attacker to corrupt the initial transmission of a UE. IUC messages are contention-based to prevent collisions and, as such, IUC messages can collect. For example, if two UEs transmit IUC messages at the same time, the ICU messages will not collide and can be collected together.

FIG. 8 is a diagram illustrating an example of an RB 800 with inter-UE coordination (e.g., as specified in 3GPP Release 17). In FIG. 8, the RB 800 has the time domain on the horizontal (or x-) axis, and the frequency domain on the vertical (or y-) axis. For example, the RB 800 may be 180 kHz wide in frequency, and one slot long in time (with a slot being 1 ms in time). The RB 800 is shown to include three subcarriers (along the y-axis) and five symbols (along the x-axis). An intersection of a symbol and subcarrier can be referred to as a RE or tone.

In FIG. 8, initial transmission resources (e.g., RE 810) can be reserved by a UE (e.g., a device, such as user device 104 of FIG. 1 or UE 221 of FIG. 2) by using IUC messages to indicate the UE's own initial transmission as “non-preferred” resources (e.g., RE 810). For example, the UE can send an IUC message within a resource (e.g., RE 830), where the IUC message can indicate a “non-preferred” resource (e.g., RE 810) for the UE to use for the UE's initial transmissions. The UE can then transmit the UE's first transmission in that “non-preferred” resource (e.g., RE 810). In FIG. 8, the retransmission resources (e.g., RE 820) can be reserved (e.g., within the SCI) by the UE.

With the use of IUC messages, since the initial transmission resources (e.g., RE 810) can be reserved by the UE, other UEs can be aware of the UE using these resources (e.g., RE 810) for its initial transmissions and the other UEs can avoid transmitting on those resources (e.g., RE 810). However, since the initial transmission resources (e.g., RE 810) can be reserved by the UE, an attacker can also be aware of those resources (e.g., RE 810) being used and, as a result, can target the initial transmissions of the UE transmitted within those resources (e.g., RE 810) by transmitting at the same time and frequency as those resources (e.g., RE 810) to collide with the UE's initial transmissions to cause the UE's initial transmission packets to get dropped.

FIG. 9 is a diagram illustrating an example of an RB 900 with inter-UE information. In FIG. 9, the RB 900 is shown with the time domain on the horizontal (or x-) axis and the frequency domain on the vertical (or y-) axis. For example, the RB 900 may be 180 kHz wide in frequency, and one slot long in time (e.g., a slot being one ms in time). The RB 900 is illustrated to include three subcarriers (along the y-axis) and five symbols (along the x-axis). An intersection of a symbol and subcarrier may be referred to as a RE or tone.

For the example shown in FIG. 9, IUC messages (e.g., containing IUC information) can be transmitted by a UE (e.g., a device, such as user device 104 of FIG. 1 or UE 221 of FIG. 2) in every other slot (e.g., on REs 910a, 910b, 910c of every other slot), on one subchannel (e.g., on the bottom row of RB 900), on a contention-based basis.

In one or more aspects, the systems and techniques provide targeted sidelink DoS detection via an inter-UE coordination message. The systems and techniques can allow for UEs to exploit IUC messages to detect an attacker and take mitigation. The systems and techniques can also allow for detection of a sidelink attack during a semi-persistent scheduling regime.

In one or more aspects, a UE (e.g., a device, such as user device 104 of FIG. 1 or UE 221 of FIG. 2), which may be a Release 17 NR-V2X-enabled device, can send a number (N_{IUC}) of fake IUC messages as “bait” for potential attackers to indicate the UE's “supposed’ initial transmissions. The number N_{IUC} of IUC messages that are transmitted by the UE can be based on the CBR. In one or more examples, CBR can be defined as a portion of subchannels in a resource pool with a received signal strength indicator (RSSI) measurement that exceeds a pre-configured threshold sensed over the last 100 ms.

In one or more examples, a minimum number (Nₘᵢₙ) of IUC messages that can be sent by the UE is less than or equal to the number (N_{IUC}) of IUC messages that can be sent by the UE, which is less than or equal to the maximum number (Nₘₐₓ) of IUC messages that can be sent by the UE. As such, N_{IUC} can be within the range Nₘᵢₙ≤N_{IUC}≤Nₘₐₓ (CBR). In one illustrative example, Nₘᵢₙ can be equal to 10, N_{IUC} can be equal to 25, and Nₘₐₓ can be equal to 50.

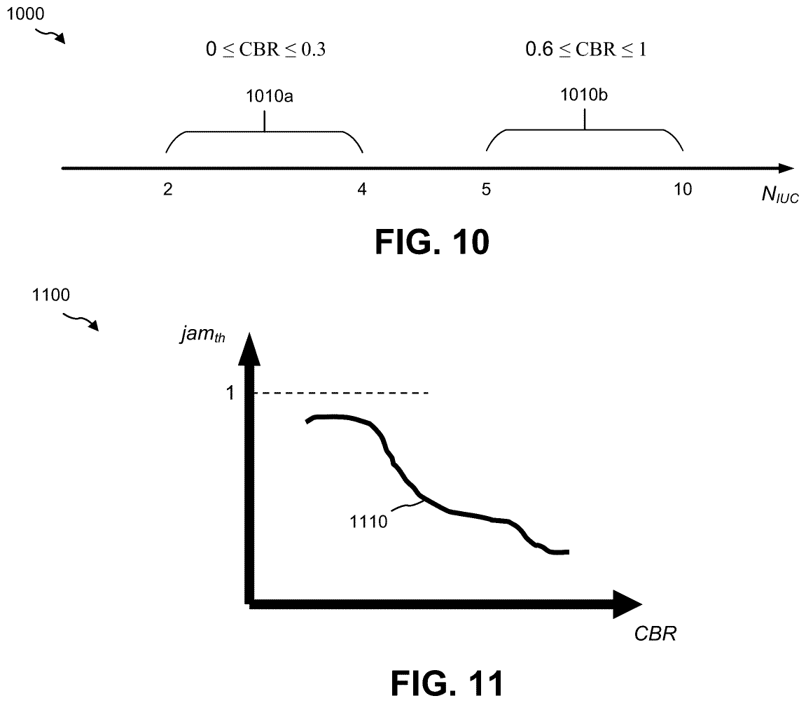

FIG. 10 is a diagram 1000 illustrating example ranges 1010a, 1010b for a number N_{IUC} of IUC messages. In FIG. 10, the horizontal axis denotes the number N_{IUC} of IUC messages to be sent by a UE. As shown in the example ranges 1010a, 1010b of FIG. 10, the number N_{IUC} of IUC messages is related to the CBR. For example, for the range 1010a, when the CBR is greater than or equal to 0 and less than or equal to 0.3, the range of number N_{IUC} of IUC messages is from 2 to 4. For range 1010b, when the CBR is greater than or equal to 0.6 and less than or equal to 1.0, the range of number N_{IUC} of IUC messages is from 5 to 10.

In one or more aspects, a UE can send at least one fake IUC message to indicate a non-preferred resource, meaning that the UE is “supposedly” going to transmit its initial transmissions on that particular resource. The fake IUC message(s) is not a real reservation of a resource for the UE's initial transmissions, but rather the fake IUC message(s) are being used by the UE as “bait” to lure in an attacker. An attacker can receive the fake IUC message(s), and then can transmit on that resource to try to jam the “supposed” upcoming initial transmissions from the UE. However, the UE will refrain from transmitting its initial transmissions on that resource. Instead, the UE can listen at the time and frequency of that resource to detect any attackers (e.g., adversaries) that are transmitting on that resource.

Benign UEs (e.g., which are not adversaries to the UE) can receive the fake IUC message(s) and believe that the UE is going to transmit its initial transmissions on that particular resource and, as such, the benign UEs (not being adversarial) will refrain from transmitting on that particular resource.

In one or more aspects, in a low CBR scenario, the number of IUC packet collisions with other transmissions should be low. As such, most of the received packets during the listening slots will likely be that of an attacker (if the attacker is present).

Conversely, in a high CBR scenario, the number of IUC packet collisions with other transmissions should be high. As such, other benign UEs may not be receiving the non-preferred resource indication in the IUC message(s) and, as a result, the benign UEs may be transmitting transmissions on the resource. The transmissions of the benign UEs should not be counted as an attacker packet. As such, there is a need for a technique to distinguish between an attacker packet and a benign UE packet, for high CBR scenarios.

In one or more examples, during operation, a UE can send the number N_{IUC} of fake IUC messages (packets) indicating a non-preferred resource that the UE is “supposedly” going to transmit its initial transmissions. The UE can then refrain from transmitting on that resource, and listen on corresponding listening slots for that resource to receive a number (N_{RX}) of packets (e.g., received packets). In one or more aspects, for high CBR scenarios (as well as for low CBR scenarios), a UE can declare the presence of an attacker when:

$$\frac{{N}_{RX}}{{N}_{IUC}} \geq {jam}_{th} ( CBR ) , \qquad Equation 1$$

where N_{IUC} is the number of fake IUC messages (packets) transmitted by the UE, N_{RX} is the number of received packets by the UE, and jamₜₕ(CBR) is a jamming threshold, which is a function of CBR. In one or more examples, it can be assumed that N_{IUC} equal to Nₘₐₓ(CBR), such that N_{IUC}=Nₘₐₓ(CBR).

FIG. 11 is a graph 1100 illustrating an example showing the relationship between the CBR and the jamming threshold, jamₜₕ(CBR). In FIG. 11, the x-axis denotes that level of CBR, and the y-axis denotes the value of the jamming threshold, jamₜₕ(CBR), which can range from 0 to 1.0. In the graph 1100, the curve 1110 specifically shows the relationship between the CBR and the jamming threshold, jamₜₕ(CBR). As shown by the curve 1110, the jamming threshold, jamₜₕ(CBR), is roughly inversely proportional to the CBR.

Equation 1 assumes that an attacker is sending legitimate V2X messages (e.g., such as BSMs). However, if an attacker is not sending V2X messages, but rather is merely jamming the RF environment, such as transmitting abnormally high power bursts, then the UE can instantly declare jamming upon reception of the high power bursts during one of the listening slots. For example, if a UE sends (transmits) a fake IUC message and, then, the UE suddenly detects a high power blast (e.g., which is not a power level normally received from other benign UEs) in the “supposed” initial transmission slot, then the UE can instantly be aware that this high power blast came from an attacker. As such, the UE does not need to listen in on all of the listening slots to evaluate the ratio (from Equation 1) to determine whether or not an attacker is present. As such, in cases where the UE receives unusual transmissions (e.g., such as high power blasts) within a “supposed” initial transmission slot, the UE can immediately determine that the unusual transmissions were transmitted by an attacker.

As previously mentioned, it can be assumed that N_{IUC}=Nₘₐₓ((BR), where to reduce latency of a DoS attack detection (e.g., for detecting an attacker), all of the number N_{IUC} of IUC messages can be sent sequentially (e.g., transmitted in every other slot, for example as shown in RB 900 of FIG. 9), before the corresponding reservation (e.g., reserved RE 810 of FIG. 8) for the initial transmissions of each is listened on. As such, the lowest latency for detection of an attacker can be achieved by transmitting all of the number N_{IUC} of IUC messages sequentially and, then, listening on the corresponding reservations of resources for the initial transmissions.

However, in high CBR scenarios, this technique (e.g., by transmitting all of the number N_{IUC} of IUC messages sequentially and, then, listening on the corresponding reservations of resources for the initial transmissions) is not an efficient use of the channel. To improve the channel efficiency, an “incremental” IUC-based detection scheme can alternatively be employed. The “incremental” IUC-based detection scheme trades off latency of detection of an attacker for channel efficiency.

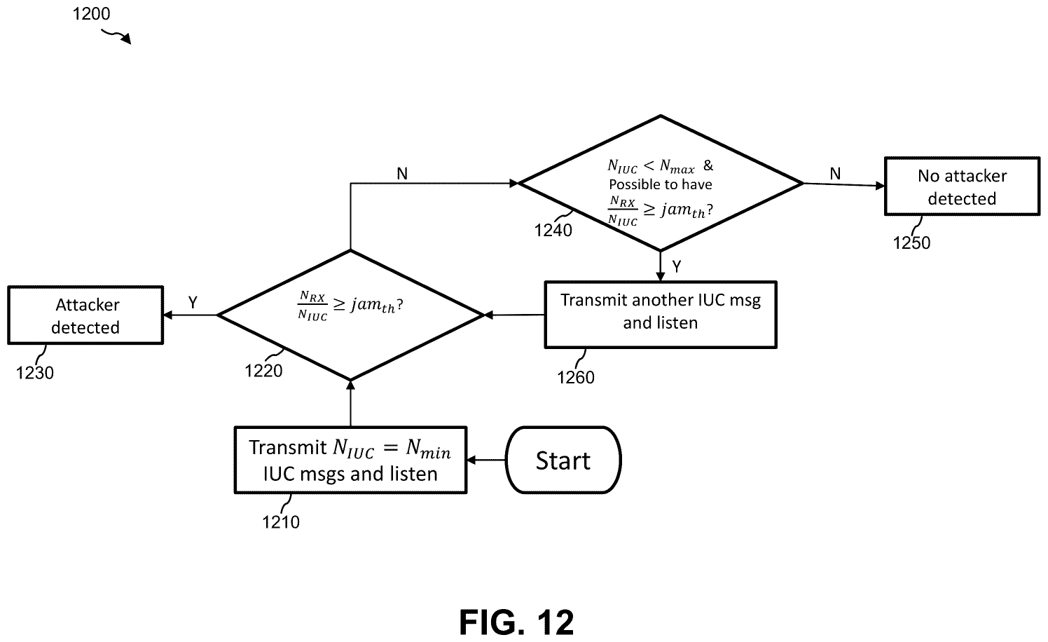

FIG. 12 shows a flow chart of an example method for the “incremental” IUC-based detection scheme. Although the “incremental” IUC-based detection scheme improves channel efficiency for detecting an attacker, the “incremental” IUC-based detection scheme can take more time to detect an attacker than the previously discussed technique (e.g., which involves transmitting all of the number N_{IUC} of IUC messages sequentially and, then, listening on the corresponding reservations of resources for the initial transmissions). For the “incremental” IUC-based detection scheme, the UE can initially start by transmitting a minimum number of fake IUC messages that can be transmitted by the UE (e.g., which may be equal to the minimum number (Nₘᵢₙ) of IUC messages that can be sent by the UE), and can continue to sequentially transmit additional fake IUC messages until the maximum number of (Nₘₐₓ) of fake IUC messages that can be transmitted by the UE has been met or until an attacker has been determined to be detected or determined to not be detected.

In particular, FIG. 12 is a flow chart illustrating an example of a method 1200 for targeted sidelink DoS detection via an IUC message. In FIG. 12, for the method 1200, at block 1210, the UE (e.g., a device, such as user device 104 of FIG. 1 or UE 221 of FIG. 2) can transmit a number N_{IUC} of fake IUC messages, where N_{IUC} equal to Nₘᵢₙ (e.g., the minimum number of IUC messages that can be transmitted by the UE). After the UE has transmitted the number N_{IUC} of IUC messages, also at block 1210, the UE can then listen on the slot(s) corresponding to the resource(s) that the UE is “supposedly” going to transmit its initial transmissions.

After the UE has listened on all of the slot(s) and received packets, at block 1220, the UE can evaluate the jamming threshold equation (Equation 1). If the UE determines that the jamming threshold equation is true (Yes), at block 1230, the UE can declare that an attacker has been detected.

However, if the UE determines that the jamming threshold equation is false (No), at block 1240, the UE can determine whether the number N_{IUC} of fake IUC messages is less than Nₘₐₓ (e.g., the maximum number of IUC messages that can be transmitted by the UE). At block 1240, the UE can also evaluate the jamming threshold equation (Equation 1). If the UE determines that the number N_{IUC} of fake IUC messages is not less than Nₘₐₓ, or that the jamming threshold equation is false (No), at block 1250, the UE can determine that no attacker has been detected.

However, if the UE determines that the number of fake IUC messages N_{IUC} less than Nₘₐₓ, and that the jamming threshold equation is true (Yes), the method 1200 proceeds to block 1260, where the UE can transmit another IUC message and, then, the UE can listen on the slot corresponding to the resource that the UE is “supposedly” going to transmit its initial transmissions. Then, the method proceeds back to block 1220, and continues as shown in the flowchart.

In one or more aspects, once an attacker had been detected, a device (e.g., a V2X-equipped device, such as a vehicle, which may be a host vehicle, or a UE) can include information related to the presence of the attacker in a vehicular-based message (e.g., a SDSM) to notify other devices (e.g., V2X-equipped devices, such as vehicles and/or UEs) of the attacker. The device can include in the SDSM information, such as its own (the victim) layer 2 (L2) address, the attacker's L2 address, the position of the attacker. This information may be useful for other remote devices (e.g., V2X-equipped devices, such as vehicles and/or UEs), if the attacker is not just targeting the one device, but rather is targeting multiple devices. As such, this information in the SDSM can notify other devices about the presence of the attacker.

In one or more aspects, the UE (e.g., device) can refrain from sending the entire ICU message. As such, the UE can omit parts of the ICU message, and can send the ICU message without the omitted parts. In one or more examples, the IUC message can indicate both the UE's own reservation of a resource(s) (e.g., RE 810 of FIG. 8) for its initial transmission as well as other UEs' reservations of resources for their initial transmissions. If a device (e.g., such as a vehicle, which may be a host vehicle, or a UE) has not received an SDSM indicating that other devices (e.g., vehicles and/or UEs) are being targeted by an attacker, the device can still send an IUC message, but not the device shall not include within the IUC message an indication of the device's own reservation of resources for the device's own initial transmissions. However, if a device (e.g., such as a vehicle, which may be a host vehicle, or a UE) has received an SDSM indicating that other devices (e.g., vehicles and/or UEs) are being targeted by an attacker, the device can simply stop sending (e.g., transmitting) any IUC messages at all. Since the device has received an indication that an attacker is attacking other devices, in order to avoid any possible targeting of the device or other devices by the attacker, the device should not send any indication of its reservation of resources for its initial transmissions and/or any indication of other devices' reservation of resources for their initial transmissions.

In one or more aspects, for devices (e.g., vehicles, such as host vehicles, or UEs) using SPS schemes, the devices are able to reserve resources for initial transmissions (e.g., not including the initial transmission of the current packet, or current transport block) for subsequent packets (e.g., subsequent transport blocks), and for all retransmissions for the current packet (e.g., current transport block) and for subsequent packets (e.g., subsequent transport blocks). A transport block (TB) can be defined as a payload for a physical layer. This SPS scenario, which allows for reserving of resources for many future transmissions, can be prone to being attacked by attackers.

In one or more examples, for an SPS scheme, a targeted attack could result in the corruption of subsequent TBs (e.g., which can include initial transmissions and retransmissions), which are subsequent to the initial transmission of the first TB in the process. This corruption can persist in the subsequent TBs, until a resource reselection occurs. After the resource reselection, the corruption of subsequent TBs can be repeated (e.g., this is referred to as “semi-persistent DoS”).

To detect and mitigate this semi-persistent DoS, a device (e.g., vehicle, such as a host vehicle, or a UE) can listen for attackers during “mute and listen” slots. “Mute and listen” slots are slots that can be reserved by the device. Instead of transmitting on those reserved slots, the device listens for potential attackers. If the device detects packets during those reserved slots, the device can then determine whether the packets were transmitted by an attacker or a benign UE. In one example, the device may use the RSSI of the received packets to determine whether the packets were transmitted from a benign UE or by an attacker (e.g., if the RSSI of the packets are above a threshold value, the device can determine that the packets were transmitted by an attacker). If the device detects an attacker during the listening to the “mute and listen” slots, the device can switch to aperiodic transmissions (e.g., and not use IUC messages for those transmissions).

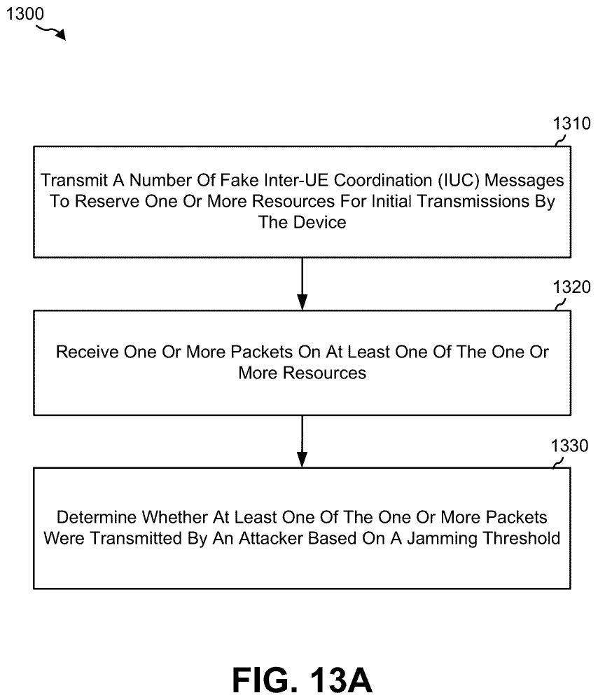

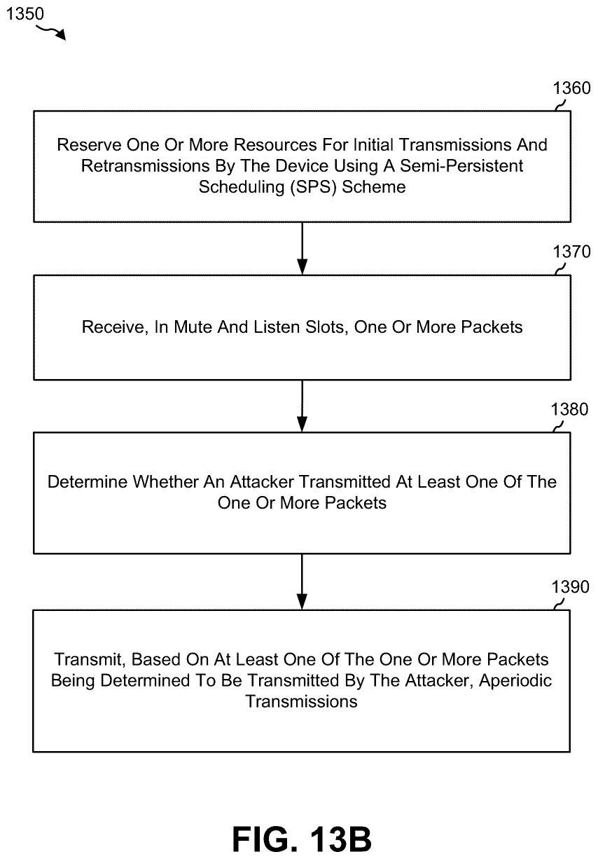

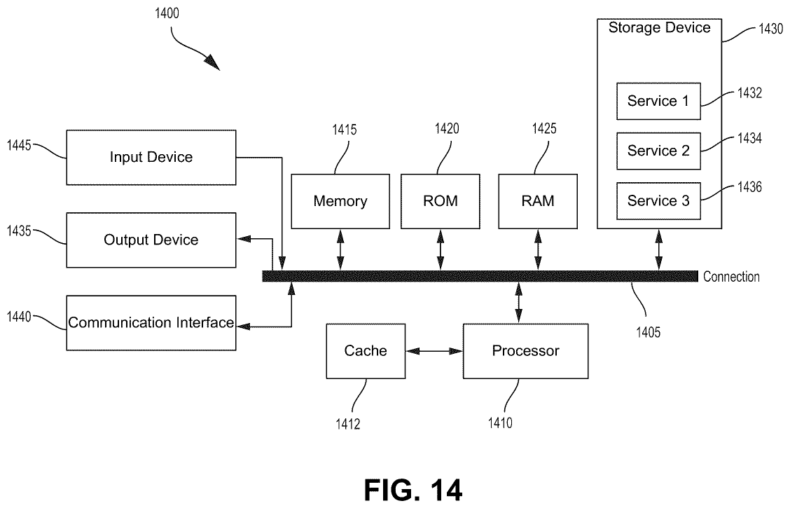

FIG. 13A is a flow chart illustrating an example of a process 1300 for wireless communications. The process 1300 can be performed by a device or by a component, system, or apparatus of the device (e.g., a chipset of the device, one or more processors of the device, or other component or system of the device). The device can be a user equipment (UE) (e.g., the user device 104 of FIG. 1, the UE 221 of FIG. 2, etc.), a base station (e.g., the base station 102 of FIG. 1, the disaggregated base station 201 of FIG. 2, etc.), a vehicle (e.g., the vehicle 404 of FIG. 4, the vehicle 510b of FIG. 5, etc.), a server, or other device. The operations of the process 1300 may be implemented as software components that are executed and run on one or more processors (e.g., processor 1410 of FIG. 14 or other processor(s)) of the device. Further, the transmission and reception of signals by the device in the process 1300 may be enabled, for example, by one or more antennas and/or one or more transceivers (e.g., wireless transceiver(s)) of the device.

At block 1310, the device (or component thereof) can transmit (or output for transmission) a number of fake inter-UE coordination (IUC) messages to reserve one or more resources for initial transmissions by the device. For instance, as described previously, the device (or component thereof) can send a number N_{IUC} of fake IUC messages as “bait” for potential attackers to indicate the UE's “supposed’ initial transmissions. In some cases, the number of fake IUC messages is based on a channel busy ratio (CBR). In some examples, the number is equal to a minimum number (e.g., Nₘᵢₙ) of IUC messages that the device can transmit. In some examples, at least one of the number of fake IUC messages further includes an indication of a reservation of one or more resources for initial transmissions of one or more other devices.

At block 1320, the device (or component thereof) can receive one or more packets on at least one of the one or more resources. In some aspects, the device (or component thereof) can listen on slots corresponding to the one or more resources. At block 1330, the device (or component thereof) can determine whether at least one of the one or more packets were transmitted by an attacker based on a jamming threshold (e.g., the jamming threshold jamₜₕ(CBR) described herein). In some cases, the jamming threshold is associated with the CBR.

In some aspects, the device (or component thereof) can determine, based on a ratio associated with a number of the one or more packets received by the device being greater than or equal to the jamming threshold

$$( e . g . , \frac{{N}_{RX}}{{N}_{IUC}} \geq {jam}_{th} ( CBR )$$

of Equation 1 above), that the at least one of the one or more packets are transmitted by the attacker. In some aspects, the device (or component thereof) can determine, based on the ratio associated with a number of the one or more packets received by the device being less than the jamming threshold

$$( e . g . , \frac{{N}_{RX}}{{N}_{IUC}} < {jam}_{th} ( CBR )$$

of Equation 1 above), that the at least one of the one or more packets are not transmitted by the attacker.

In some cases, the device (or component thereof) can transmit, based on the at least one of the one or more packets not being determined to be transmitted by the attacker, an additional fake IUC message to reserve an additional one or more resources for initial transmissions by the device. In some cases, the device (or component thereof) can transmit, based on the at least one of the one or more packets being determined to be transmitted by the attacker, a vehicular-based message. In some aspects, the vehicular-based message includes a Layer 2 (L2) address for the device, an L2 address for the attacker, a position of the attacker, a combination thereof, and/or other information. In some cases, the vehicular-based message is a Sensor Data Sharing Message (SDSM).

FIG. 13B is a flow chart illustrating an example of a process 1350 for wireless communications. The process 1350 can be performed by a device or by a component, system, or apparatus of the device (e.g., a chipset of the device, one or more processors of the device, or other component or system of the device). The device can be a user equipment (UE) (e.g., the user device 104 of FIG. 1, the UE 221 of FIG. 2, etc.), a base station (e.g., the base station 102 of FIG. 1, the disaggregated base station 201 of FIG. 2, etc.), a vehicle (e.g., the vehicle 404 of FIG. 4, the vehicle 510b of FIG. 5, etc.), a server, or other device. The operations of the process 1350 may be implemented as software components that are executed and run on one or more processors (e.g., processor 1410 of FIG. 14 or other processor(s)) of the device. Further, the transmission and reception of signals by the device in the process 1350 may be enabled, for example, by one or more antennas and/or one or more transceivers (e.g., wireless transceiver(s)) of the device.

At block 1360, the device (or component thereof) can reserve one or more resources for initial transmissions and retransmissions by the device using a semi-persistent scheduling (SPS) scheme. For example, as previously described, the device can use an SPS scheme to reserve resources for initial transmissions (e.g., not including the initial transmission of the current packet, or current transport block) for subsequent packets (e.g., subsequent transport blocks), and for all retransmissions for the current packet (e.g., current transport block) and for subsequent packets (e.g., subsequent transport blocks).

At block 1370, the device (or component thereof) can receive, in mute and listen slots, one or more packets. For instance, as described previously, to detect and mitigate an attack (e.g., a semi-persistent DOS attack), the device (e.g., vehicle, such as a host vehicle, or a UE) can listen for attackers during mute and listen slots. Instead of transmitting on the reserved slots, the device can listen for packets (e.g., the one or more packets) from potential attackers.

At block 1380, the device (or component thereof) can determine whether an attacker transmitted at least one of the one or more packets. In some cases, the device can determine whether the at least one of the one or more packets were transmitted by the attacker based on a signal strength (e.g., RSSI or other measure of signal strength) of the at least one of the one or more packets received by the device. For instance, as previously described, if the device detects packets during the reserved slots (e.g., the one or more packets), the device can then determine whether the packets were transmitted by an attacker or by a benign UE (a non-attacker). In one example, the device may use the RSSI of the received packets to determine whether the packets were transmitted from a benign UE or by an attacker (e.g., if the RSSI of the packets are above a threshold value, the device can determine that the packets were transmitted by an attacker).

At block 1390, the device (or component thereof) can transmit, based on at least one of the one or more packets being determined to be transmitted by the attacker, aperiodic transmissions. For instance, if the device detects an attacker while listening to the mute and listen slots, the device can switch to aperiodic transmissions (e.g., and not use IUC messages for those transmissions).

FIG. 14 is a block diagram illustrating an example of a computing system 1400, which may be employed by the disclosed system for targeted sidelink DoS detection via an inter-UE coordination message. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LIDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A method for wireless communications by a device, the method comprising: transmitting, by the device, a number of fake inter-UE coordination (IUC) messages to reserve one or more resources for initial transmissions by the device; receiving, by the device, one or more packets on at least one of the one or more resources; and determining, by the device, whether at least one of the one or more packets were transmitted by an attacker based on a jamming threshold.
Aspect 2. The method of Aspect 1, wherein the number of fake IUC messages is based on a channel busy ratio (CBR).
Aspect 3. The method of any one of Aspects 1 or 2, wherein the jamming threshold is associated with a channel busy ratio (CBR).
Aspect 4. The method of any one of Aspects 1 to 3, further comprising listening, by the device, on slots corresponding to the one or more resources.
Aspect 5. The method of any one of Aspects 1 to 4, wherein the device is one of a user equipment, a vehicle, a base station, or a server.
Aspect 6. The method of any one of Aspects 1 to 5, wherein the number is equal to a minimum number of IUC messages that the device can transmit.
Aspect 7. The method of Aspect 6, further comprising transmitting, by the device based on the at least one of the one or more packets not being determined to be transmitted by the attacker, an additional fake IUC message to reserve an additional one or more resources for initial transmissions by the device.
Aspect 8. The method of any one of Aspects 1 to 7, further comprising determining, by the device based on a ratio associated with a number of the one or more packets received by the device being greater than or equal to the jamming threshold, that the at least one of the one or more packets are transmitted by the attacker.
Aspect 9. The method of any one of Aspects 1 to 8, further comprising determining, by the device based on a ratio associated with a number of the one or more packets received by the device being less than the jamming threshold, that the at least one of the one or more packets are not transmitted by the attacker.
Aspect 10. The method of any one of Aspects 1 to 9, further comprising transmitting, by the device based on the at least one of the one or more packets being determined to be transmitted by the attacker, a vehicular-based message.
Aspect 11. The method of Aspect 10, wherein the vehicular-based message comprises at least one of a Layer 2 (L2) address for the device, an L2 address for the attacker, or a position of the attacker.
Aspect 12. The method of any one of Aspects 10 or 11, wherein the vehicular-based message is a Sensor Data Sharing Message (SDSM).
Aspect 13. The method of any one of Aspects 1 to 12, wherein at least one of the number of fake IUC messages further comprises an indication of a reservation of one or more resources for initial transmissions of one or more other devices.
Aspect 14. An apparatus for wireless communications, the apparatus comprising: at least one memory; and at least one processor coupled to the at least one memory and configured to: output for transmission a number of fake inter-UE coordination (IUC) messages to reserve one or more resources for initial transmissions by the apparatus; receive one or more packets on at least one of the one or more resources; and determine whether at least one of the one or more packets were transmitted by an attacker based on a jamming threshold.
Aspect 15. The apparatus of Aspect 14, wherein the number of fake IUC messages is based on a channel busy ratio (CBR).
Aspect 16. The apparatus of any one of Aspects 14 or 15, wherein the jamming threshold is associated with a channel busy ratio (CBR).
Aspect 17. The apparatus of any one of Aspects 14 to 16, wherein the at least one processor is configured to listen on slots corresponding to the one or more resources.
Aspect 18. The apparatus of any one of Aspects 14 to 17, wherein the apparatus is one of a user equipment, a vehicle, a base station, or a server.
Aspect 19. The apparatus of any one of Aspects 14 to 18, wherein the number is equal to a minimum number of IUC messages that the apparatus can transmit.
Aspect 20. The apparatus of Aspect 19, wherein the at least one processor is configured to output for transmission, based on the at least one of the one or more packets not being determined to be transmitted by the attacker, an additional fake IUC message to reserve an additional one or more resources for initial transmissions by the apparatus.
Aspect 21. The apparatus of any one of Aspects 14 to 20, wherein the at least one processor is configured to determine, based on a ratio associated with a number of the one or more packets received by the apparatus being greater than or equal to the jamming threshold, that the at least one of the one or more packets are transmitted by the attacker.
Aspect 22. The apparatus of any one of Aspects 14 to 21, wherein the at least one processor is configured to determine, based on a ratio associated with a number of the one or more packets received by the apparatus being less than the jamming threshold, that the at least one of the one or more packets are not transmitted by the attacker.
Aspect 23. The apparatus of any one of Aspects 14 to 22, wherein the at least one processor is configured to output a vehicular-based message for transmission based on the at least one of the one or more packets being determined to be transmitted by the attacker.
Aspect 24. The apparatus of Aspect 23, wherein the vehicular-based message comprises at least one of a Layer 2 (L2) address for the apparatus, an L2 address for the attacker, or a position of the attacker.
Aspect 25. The apparatus of any one of Aspects 23 or 24, wherein the vehicular-based message is a Sensor Data Sharing Message (SDSM).
Aspect 26. The apparatus of any one of Aspects 14 to 25, wherein at least one of the number of fake IUC messages further comprises an indication of a reservation of one or more resources for initial transmissions of one or more devices.
Aspect 27. A method for wireless communications by a device, the method comprising: reserving, by the device, one or more resources for initial transmissions and retransmissions by the device using a semi-persistent scheduling (SPS) scheme; receiving, by the device in mute and listen slots, one or more packets; determining, by the device, whether an attacker transmitted at least one of the one or more packets; and transmitting, by the device and based on at least one of the one or more packets being determined to be transmitted by the attacker, aperiodic transmissions.
Aspect 28. The method of Aspect 27, further comprising determining, by the device, whether the at least one of the one or more packets were transmitted by the attacker based on a signal strength of the at least one of the one or more packets received by the device.
Aspect 29. An apparatus for wireless communications, the apparatus comprising: at least one memory; and at least one processor coupled to the at least one memory and configured to: reserve one or more resources for initial transmissions and retransmissions by the apparatus using a semi-persistent scheduling (SPS) scheme; receive, in mute and listen slots, one or more packets; determine whether an attacker transmitted at least one of the one or more packets; and based on at least one of the one or more packets being determined to be transmitted by the attacker, output aperiodic transmissions.
Aspect 30. The apparatus of Aspect 29, wherein the at least one processor is configured to determine whether the at least one of the one or more packets were transmitted by the attacker based on a signal strength of the at least one of the one or more packets received by the device.
Aspect 31. A non-transitory computer-readable medium having stored thereon instructions that, when executed by at least one processor, cause the at least one processor to perform operation according to any of Aspects 1 to 13.
Aspect 32. An apparatus for wireless communications, comprising one or more means for performing operations according to any of Aspects 1 to 13.
Aspect 33. A non-transitory computer-readable medium having stored thereon instructions that, when executed by at least one processor, cause the at least one processor to perform operations according to any of Aspects 27 or 28.
Aspect 34. An apparatus for wireless communications, comprising one or more means for performing operations according to any of Aspects 27 or 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for wireless communications by a device, the method comprising:
transmitting, by the device, a number of fake inter-UE coordination (IUC) messages to reserve one or more resources for initial transmissions by the device;
receiving, by the device, one or more packets on at least one of the one or more resources; and
determining, by the device, whether at least one of the one or more packets were transmitted by an attacker based on a jamming threshold.

2. The method of claim 1, wherein the number of fake IUC messages is based on a channel busy ratio (CBR).

3. The method of claim 1, wherein the jamming threshold is associated with a channel busy ratio (CBR).

4. The method of claim 1, further comprising listening, by the device, on slots corresponding to the one or more resources.

5. The method of claim 1, wherein the device is one of a user equipment, a vehicle, a base station, or a server.

6. The method of claim 1, wherein the number is equal to a minimum number of IUC messages that the device can transmit.

7. The method of claim 6, further comprising transmitting, by the device based on the at least one of the one or more packets not being determined to be transmitted by the attacker, an additional fake IUC message to reserve an additional one or more resources for initial transmissions by the device.

8. The method of claim 1, further comprising determining, by the device based on a ratio associated with a number of the one or more packets received by the device being greater than or equal to the jamming threshold, that the at least one of the one or more packets are transmitted by the attacker.

9. The method of claim 1, further comprising determining, by the device based on a ratio associated with a number of the one or more packets received by the device being less than the jamming threshold, that the at least one of the one or more packets are not transmitted by the attacker.

10. The method of claim 1, further comprising transmitting, by the device based on the at least one of the one or more packets being determined to be transmitted by the attacker, a vehicular-based message.

11. The method of claim 10, wherein the vehicular-based message comprises at least one of a Layer 2 (L2) address for the device, an L2 address for the attacker, or a position of the attacker.

12. The method of claim 10, wherein the vehicular-based message is a Sensor Data Sharing Message (SDSM).

13. The method of claim 1, wherein at least one of the number of fake IUC messages further comprises an indication of a reservation of one or more resources for initial transmissions of one or more other devices.

14. An apparatus for wireless communications, the apparatus comprising:
at least one memory; and
at least one processor coupled to the at least one memory and configured to:
output for transmission a number of fake inter-UE coordination (IUC) messages to reserve one or more resources for initial transmissions by the apparatus;
receive one or more packets on at least one of the one or more resources; and
determine whether at least one of the one or more packets were transmitted by an attacker based on a jamming threshold.

15. The apparatus of claim 14, wherein the number of fake IUC messages is based on a channel busy ratio (CBR).

16. The apparatus of claim 14, wherein the jamming threshold is associated with a channel busy ratio (CBR).

17. The apparatus of claim 14, wherein the at least one processor is configured to listen on slots corresponding to the one or more resources.

18. The apparatus of claim 14, wherein the apparatus is one of a user equipment, a vehicle, a base station, or a server.

19. The apparatus of claim 14, wherein the number is equal to a minimum number of IUC messages that the apparatus can transmit.

20. The apparatus of claim 19, wherein the at least one processor is configured to output for transmission, based on the at least one of the one or more packets not being determined to be transmitted by the attacker, an additional fake IUC message to reserve an additional one or more resources for initial transmissions by the apparatus.

21. The apparatus of claim 14, wherein the at least one processor is configured to determine, based on a ratio associated with a number of the one or more packets received by the apparatus being greater than or equal to the jamming threshold, that the at least one of the one or more packets are transmitted by the attacker.

22. The apparatus of claim 14, wherein the at least one processor is configured to determine, based on a ratio associated with a number of the one or more packets received by the apparatus being less than the jamming threshold, that the at least one of the one or more packets are not transmitted by the attacker.

23. The apparatus of claim 14, wherein the at least one processor is configured to output a vehicular-based message for transmission based on the at least one of the one or more packets being determined to be transmitted by the attacker.

24. The apparatus of claim 23, wherein the vehicular-based message comprises at least one of a Layer 2 (L2) address for the apparatus, an L2 address for the attacker, or a position of the attacker.

25. The apparatus of claim 23, wherein the vehicular-based message is a Sensor Data Sharing Message (SDSM).

26. The apparatus of claim 14, wherein at least one of the number of fake IUC messages further comprises an indication of a reservation of one or more resources for initial transmissions of one or more devices.

27. A method for wireless communications by a device, the method comprising:
reserving, by the device, one or more resources for initial transmissions and retransmissions by the device using a semi-persistent scheduling (SPS) scheme;
receiving, by the device in mute and listen slots, one or more packets;
determining, by the device, whether an attacker transmitted at least one of the one or more packets; and
transmitting, by the device and based on at least one of the one or more packets being determined to be transmitted by the attacker, aperiodic transmissions.

28. The method of claim 27, further comprising determining, by the device, whether the at least one of the one or more packets were transmitted by the attacker based on a signal strength of the at least one of the one or more packets received by the device.

29. An apparatus for wireless communications, the apparatus comprising:
at least one memory; and
at least one processor coupled to the at least one memory and configured to:
reserve one or more resources for initial transmissions and retransmissions by the apparatus using a semi-persistent scheduling (SPS) scheme;
receive, in mute and listen slots, one or more packets;
determine whether an attacker transmitted at least one of the one or more packets; and
based on at least one of the one or more packets being determined to be transmitted by the attacker, output aperiodic transmissions.

30. The apparatus of claim 29, wherein the at least one processor is configured to determine whether the at least one of the one or more packets were transmitted by the attacker based on a signal strength of the at least one of the one or more packets received by the device.
